(19) United States
(12) Patent Application Publication
(10) Pub. No.: US 2025/0008976 A1
(43) Pub. Date: Jan. 9, 2025

(54) PRECISELY INFUSED COFFEE PRODUCTS AND METHODS OF MAKING THE SAME

(71) Applicant: Almor Group LLC Dba Ott Coffee, Austin, TX (US)

(72) Inventors: Alwan MORTADA, Austin, TX (US); Shahram R. SHAFIE, Austin, TX (US)

(73) Assignee: Almor Group LLC Dba Ott Coffee, Austin, TX (US)

(21) Appl. No.: 18/346,368

(22) Filed: Jul. 3, 2023

(51) Int. Cl. A23F 5/14; A23F 5/04; A23F 5/46; A23L 33/105

(52) U.S. Cl. CPC A23F 5/14; A23F 5/04; A23F 5/465; A23L 33/105; A23F 2200/00

(57) ABSTRACT

Provided herein are infused coffee products and methods of making such infused coffee products. The method includes placing the roasted coffee beans in a chamber, heating an additive to a temperature between about 35° C. and about 130° C., adding the heated additive to the roasted coffee beans in the chamber while mixing and/or tumbling the roasted coffee beans; and mixing the roasted coffee beans and the additive to produce infused coffee beans.

### TECHNICAL FIELD

The present disclosure provides precisely infused coffee beans, products, and methods of making such compositions.

### BACKGROUND

Recently, cannabinoid infused coffee products have been entering the commercial market. Generally, creating infused coffee products have been accomplished by either spraying one or more additives, such as CBD, onto roasted coffee or sprinkling additives onto ground coffee, both methods may alter the flavor and aroma of the final product. Moreover, both methods only coat the surface of coffee beans and does not result in adsorption and/or absorption of a desired compound into the core of coffee beans. Furthermore, studies have shown that the roasting process causes meaningful changes in the microstructure of the coffee bean tissue, showing significant changes in the pore structure after roasting. (See. e.g., Paola Pittia et al. Evaluation of microstructural properties of coffee beans by synchrotron X-ray microtomography: a methodological approach”, 76 J. of Food Science, (2011) pages 222-231.)

Conventional methods of applying an additive to the exterior surface of beans only result in trace amounts of CBD on the beans. This is because the CBD material evaporates or decomposes when exposed to the high temperatures involved in roasting. Some other processes use chemical solvents like ethyl acetate or methylene chlorides to infuse CBD into green coffee beans, which risks the consumption of harmful chemical residues by the user. Various existing methods render the cannabinoid molecules susceptible to degradation at temperatures above, e.g., 125° C., leading to the destruction of chemical bonding and molecular structures. Analysis of CBD infused coffee indicate that only a very small amount of cannabinoid, if any, is present in the brewed beverage (see, e.g., U.S. Pat. No. 10,485,373).

It is difficult to consistently infuse cannabinoids across all roasted coffee beans in a batch, and thus there is a challenge in providing consistent dosing. Existing methods fail to account for the complexities of infusing coffee with consistent, accurate, and sufficient doses of additive compounds to avoid overdosing or underdosing users. Moreover, some existing methods use chemical binding agents. Further, various existing methods detrimentally alter the flavor and/or aroma profiles of coffee.

Thus, there exist needs to develop methods that produce infused coffee products that contain precise, consistent and desired dosages of one or multiple additives, while retaining the appropriate natural coffee flavor and aroma for human consumption.

### SUMMARY OF THE INVENTION

The present disclosure includes additive infused coffee beans and coffee products. In one aspect, the infused coffee product is infused coffee beans. In another aspect, the infused coffee product is infused cold brew. In another aspect, the infused coffee product is ground coffee beans. In another aspect, the infused coffee product is a brewed infused coffee beverage.

In one aspect, the present disclosure includes a method of making an infused coffee bean product comprising a desired dosage of an additive by mixing precise ratios of the additive and the coffee beans and heating the mixture of the coffee beans and the additive at sufficient times and temperatures to effect chemical bonding or mixing between the oils present in the coffee beans and the additive, without degrading the chemical structures of the additive molecules and without degrading the oils in the coffee beans.

In one aspect, the present disclosure includes a method of making an infused coffee bean product comprising a desired dosage of an additive, comprising the steps of:
(i) obtaining green coffee beans;
(ii) roasting the green coffee beans at an elevated temperature, e.g., which can be defined by the level and type of roasting;
(iii) removing the roasted coffee beans of step (ii) from heat;
(iv) cooling the roasted coffee beans to a temperature between about 60° C. (140° F.) and about 130° C. (266° F.);
(v) placing the roasted coffee beans of step (iv) in a chamber;
(vi) heating an additive to a temperature between about 35° C. (95° F.) and about 130° C. (266° F.);
(vii) adding the heated additive of step (vii) to the roasted coffee beans of step (v) in the chamber while mixing and/or tumbling the roasted coffee beans; and
(viii) mixing the roasted coffee beans and the additive to produce infused coffee beans.

In one aspect, the present disclosure includes a method of making an infused coffee bean product comprising a desired dosage of an additive, comprising the steps of:
(i) obtaining green coffee beans;
(ii) roasting the green coffee beans at an elevated temperature to a desired roast;
(iii) removing the roasted coffee beans of step (ii) from heat;
(iv) cooling the roasted coffee beans to a temperature between 38° C.±3° C. and 121° C.±3° C.;
(v) mixing the cooling roasted coffee beans of step (iv) in a chamber for mixing the roasted coffee beans;
(vi) obtaining an amount of an additive relative to the amount of roasted coffee beans that is 3 wt % to 28 wt % higher than the desired dosage (as determined by a w/w ratio between the additive and the roasted coffee beans);
(vii) heating the additive to a temperature between 38° C.±3° C. and 121° C.±3° C.;
(viii) adding the heated additive of step (vii) to the coffee beans of step (v) while mixing and/or tumbling the roasted coffee beans;
(ix) mixing the coffee beans and the additive for between 5 minutes and 40 minutes to produce infused coffee beans; and
(x) cooling the infused coffee beans.

In one aspect, the final cooling step is to room temperature.

In one aspect, the final cooling step is to 22 to 28° C.

In one aspect, the final cooling step is to 4 to 20° C.

In one aspect, the final cooling step is to −10 to 3° C.

In one aspect, the roasted coffee beans of step (ii) are removed from heat at a temperature from about 180° C.±3° C. to about 230° C.±3° C. In one aspect, the roasted coffee beans of (iv) are maintained at a temperature of 38° C.±3° C. to 121° C.±3° C. while being transferred to the chamber for mixing. In one aspect, the roasted coffee beans are maintained at a temperature from about 82° C.±3° C. to about 104° C.±3° C. throughout the mixing process. In one aspect, the roasted coffee beans of the disclosure are maintained at a temperature from about 90±3° C. to 100±3° C. throughout the mixing process. In one aspect, the roasted coffee beans and the additive are mixed for a period between 10 minutes and 30 minutes.

In one aspect, the desired roast is at least one of: light roast (about 180° C. to about 205° C.), medium roast (about 206° C. to about 222° C.), and dark roast (about 222° C. to about 235° C.). Light roasted beans generally reach an internal temperature of 180° C.-205° C. (356° F.-401° F.). At or around 205° C., the beans pop or crack and expand in size. This is known as the “first crack”. So a light roast means a coffee that has not been roasted beyond the first crack. Medium roasts are roasted further to between the end of the first crack and just before the beginning of the second crack. To reach the level of a dark roast, coffee beans are roasted to about the end of the second crack or beyond.

In one aspect, the present disclosure provides a method of making an infused coffee bean product comprising a desired dosage of an additive, comprising the steps of:
(i) obtaining roasted coffee beans (e.g., having a desired roast), wherein the roasted coffee beans may be at or below room temperature;
(ii) heating the roasted coffee beans to a temperature between about 60° C. and about 155° C.;
(iii) placing the roasted coffee beans of step (ii) in a chamber for mixing the coffee beans;
(iv) heating an additive to a temperature from 38° C.±3° C. to 121° C.±3° C.;
(vi) adding the heated additive of step (iv) to the roasted coffee beans of (iii) in the chamber while mixing and/or tumbling the roasted coffee beans; and
(vii) mixing the coffee beans and the additive for a period between about 5-75 minutes to produce infused coffee beans.

In one aspect, the present disclosure provides a method of making an infused coffee bean product comprising a desired dosage of an additive, comprising the steps of:
(i) obtaining roasted coffee beans (e.g., having a desired roast), wherein the roasted coffee beans may be at or below room temperature;
(ii) heating the roasted coffee beans to a temperature of 65° C.±3° C. to 149° C.±3° C., wherein the coffee beans comprise about 5% to about 200% oil by weight based on the total weight of the coffee beans;
(iii) moving the coffee beans of (ii) to a chamber for mixing the coffee beans;
(iv) obtaining an amount of an additive comprising a weight relative to the amount of roasted coffee beans that is 3 wt % to 28 wt % higher than the desired dosage (as determined by a w/w ratio between the additive and the roasted coffee beans);
(v) heating the additive to a temperature from 38° C.±3° C. to 121° C.±3° C.;
(vi) adding the heated additive of step (v) to the coffee beans of step (iii) in the chamber while mixing and/or tumbling the roasted coffee beans;
(vii) mixing the coffee beans and additive for a period between 5 minutes and 70 minutes to produce infused coffee beans; and
(viii) cooling the infused coffee beans.

In one aspect, the final cooling step is to room temperature.

In one aspect, the final cooling step is to 22 to 28° C.

In one aspect, the final cooling step is to 4 to 20° C.

In one aspect, the final cooling step is to −10 to 3° C.

In one aspect, the heated coffee beans of step (ii) comprise about 9% to about 17% oil by weight based on the total weight of the coffee beans. In one aspect, the coffee beans are maintained at a temperature from 38° C.±3° C. to about 149° C.±3° C. throughout the mixing process. In one aspect, the coffee beans are maintained at a temperature from about 90±3° C. to 100±3° C. throughout the mixing process. In one aspect, the roasted coffee beans and the additive are mixed for about 10 minutes and about 60 minutes.

In one aspect, the additive added to roasted or green coffee beans is in the form of a water-based or water-soluble powder, an isolate, an oil, or an extract. In one aspect, the additive is introduced to water, distilled water or mineralized water. In some aspects, cannabinoids and cannabinoid mixtures are provided in the following forms:
Isolate powder: a range of 98% to 99.99% concentration of a cannabinoid or mixture of cannabinoids.
Distillate oil: a range of 70%-98% concentration of a cannabinoid or mixture of cannabinoids.
Crude oil: a range of 55%-75% concentration of a cannabinoid or mixture of cannabinoids.
water soluble (nanoparticles): a range of 20% to 30% of a cannabinoid or mixture of cannabinoids.

In one aspect, the additive is heated to a temperature of 38° C.±3° C. to 121° C.±3° C.

In one aspect, the infused coffee beans of the disclosure are pasteurized after infusion. In one aspect, the pasteurization comprises (1) exposing the coffee beans to a temperature of 60° C.±3° C. to 100° C.±3° C. for 3 to 30 seconds and (2) exposing the coffee beans to 4° C.±3° C. to 93° C.±3° C. In one aspect, the coffee beans of step (ii) and the additive are heated using a nonreactive heat source. In some aspects, the nonreactive heat source is ultraviolet light (UV-C), hot air, radiant, light source, or conductive heat.

In one aspect, the mixing and/or tumbling of coffee beans and additive is at a rotating speed of about 5 to about 35 RPM, 10 to 30 RPM, 15 to 25 RPM, 17-22 RPM or any speed between about 5-35 RPM. In some aspects, the additive is added to the coffee beans at a ratio of about 0.1 wt % to about 2.5 wt % of the coffee beans' weight before heating or roasting. In some aspects, 3 wt % to 28 wt % of the additive(s) added to the coffee beans are lost after heating or roasting. In some aspects, 5 wt % to 20 wt % of the additive(s) added to the coffee beans are lost after heating or roasting.

In one aspect, the present disclosure provides a method of making a cold brew product, comprising:
(i) introducing ground coffee beans to a first volume of water, distilled water, or mineralized water in an airtight tank at:
   (1) a temperature from about 30° C. to about 95° C. for less than 90 seconds or less than 60 seconds, then
   (2) a temperature from about 1° C. to about 100° C. for less than 90 seconds or less than 60 seconds;
(ii) reducing the temperature of the tank to about 0° C. to about 15° C.;
(iii) steeping the coffee ground in water mixture for about 12 to 24 hours;
(iv) obtaining an amount of an additive at a desired dosage;
(v) introducing the additive to water in a second airtight tank at a temperature from about 30° C. to about 98° C.;
(vi) filtering the coffee in water mixture of step (iii) to remove the coffee grounds from the filtered coffee liquid, wherein the filtered coffee liquid is at a second volume that is about 20% less than the first volume; and
(vii) adding the additive in water mixture of step (v) to the filtered coffee liquid of step (vi) at a temperature of about 10° C. to about 105° C. to make the cold brew solution, wherein the added of the additive in water mixture is about 20% of the first volume.

In one aspect, the present disclosure provides a method of making a cold brew product, comprising:
(i) introducing ground coffee beans to a first volume of water, distilled water, or mineralized water in an airtight tank at:
   (1) a temperature from 38° C.±3° C. to 90° C.±3° C. for less than 60 seconds, then
   (2) a temperature from 4° C.±3° C. to 93° C.±3° C. for less than 60 seconds;
(ii) reducing the temperature of the tank to 0° C.±3° C. to 10° C.±3° C.;
(iii) steeping the coffee grounds in a water mixture for about 16 to 24 hours;
(iv) obtaining an amount of an additive at a desired dosage;
(v) introducing the additive to water in a second airtight tank at a temperature from 37° C.±3° C. to 94° C.±3° C.;
(vi) filtering the coffee in water mixture of (iii) to remove the coffee grounds from the filtered coffee liquid, wherein the filtered coffee liquid is at a second volume that is about 20% less than the first volume; and
(vii) adding the additive in water mixture of step (v) to the filtered coffee liquid of step (vi) at a temperature of 18° C.±3° C. to 100° C.±3° C. to make the cold brew solution, wherein the added of the additive in water mixture is about 20% of the first volume.

In one aspect, the method further comprises packaging the cold brew solution of (vii) in a suitable container. In one aspect, the cold brew solution of (vi) is packaged under airtight conditions. In one aspect, the airtight condition is maintained through continuous circulation of a gas, wherein the gas is not oxygen. In one aspect, the gas is nitrogen or carbon dioxide. In one aspect, the pH of cold brew solution of (vi) is below 5. In one aspect, the suitable container is a can, a bottle, or a carton.

In one aspect, the cold brew solution of (vii) is pasteurized. In one aspect, the pasteurization introducing ground coffee beans to a first volume of water in an airtight tank at: (1) a temperature from 38° C.±3° C. to 90° C.±3° C. for less than 60 seconds; then (2) a temperature from 4° C.±3° C. to 93° C.±3° C. for less than 60 seconds. In one aspect, the pasteurization comprises exposing the packaged cold brew to a temperature between 115° C.±3° C. to 130° C.±3° C. and pressure between 0.7±0.1 kg/cm² (10 psi±1.4) to 1.5±0.1 kg/cm² (21.3 psi±1.4). In one aspect, an antimicrobial agent is added to the cold brew solution of (vi). In some aspects, a nitrogen infusion process is used to preserve the cold brew beverage.

In one aspect, the additive of (vi) is in the form of a water-based powder or water-soluble powder, an isolate, an oil, or an extract. In one aspect, the additive of (vii) is introduced to water, distilled water, mineralized water, milk, creamer, non-dairy milk substitute, or non-dairy creamer.

In one aspect, the additive of the disclosure comprises, consists of, or consists essentially of one or more cannabinoids. In some aspects, the cannabinoid is THC (tetrahydrocannabinol, including delta-9-, delta-8-, delta-10-tetrahydrocannabinol), THCV (Tetrahydrocannabivarin) THCA (tetrahydrocannabinolic acid). CBD (cannabidiol), CBDA (cannabidiolic acid), CBN (cannabinol), CBG (cannabigerol), CBC (cannabichromene), CBL (cannabicyclol), CBV (cannabivarin), THCC (tetrahydrocannabiorcol), THCV (tetrahydrocannabivarin), THCP (tetrahydrocannabiphorol), CBDV (cannabidivarin), CBCV (cannabichromevarin), CBGV (cannabigerovarin), CBGM (cannabigerol monomethyl ether), CBE (cannabielsoin), CBT (cannabicitran), and mixtures thereof.

In some aspects, the additive comprises, consists of, or consists essentially of an adaptogen. In some aspects, the adaptogen is ashwagandha, Rhodiola rosea, Panax ginseng, Panax quinquefolius, holy basil, eleuthero, Cordyceps, reishi, maca, Schisandra, or licorice root.

In some aspects, the additive comprises, consists of, or consists essentially of a hemp extract. In some aspects, the additive is an amino acid. In some aspects, the amino acid is L-theanine, or GABA (γ-aminobutyric acid). In some aspects, the additive may also comprise, consist of, or consist essentially of a vitamin and/or a terpene. In some aspects, the terpene is myrcene, limonene, pinene, caryophyllene, and linalool.

In one aspect, the additive contains a cannabinoid in combination with at least one selected from a terpene, an adaptogen, an amino acid, and a vitamin.

Each of the aspects of the present disclosure can encompass various elements of the present disclosure. It is, therefore, anticipated that each of the aspects of the present disclosure involving any one element or combinations of elements can be included in each aspect of the present disclosure. This disclosure is not limited in its application to the details of construction and the arrangement of components set forth in the following detailed description.

### DETAILED DESCRIPTION

Although the present disclosure is described in detail below, it is to be understood that this disclosure is not limited to the particular methodologies, protocols and reagents described herein as these may vary. It is also to be understood that the terminology used herein is for the purpose of describing particular aspects only, and is not intended to limit the scope of the present disclosure. Unless defined otherwise, all technical and scientific terms used herein have the same meanings as commonly understood by one of ordinary skill in the art.

### Definitions

As used herein, the singular forms “a,” “an,” and “the” include plural references, unless the content clearly dictates otherwise, and are used interchangeably with “at least one” and “one or more.”

As used herein, the terms “comprises,” “comprising,” “includes,” “including,” “contains,” “containing,” and any variations thereof, are intended to cover a non-exclusive inclusion, such that a process, method, or composition of matter that comprises, includes, or contains an element or list of elements does not include only those elements but may include other elements not expressly listed or inherent to such process, method, product-by-process, or composition of matter.

As used herein, “bioavailability” refers to the physiological availability of a given amount of a drug as distinct from its chemical potency, a proportion of the administered dose that is absorbed into the bloodstream.

As used herein, “green bean” refers to a coffee bean prior to roasting. A ripe, freshly harvested green bean typically has between 45% and 55% moisture content. After being dried and processed, the moisture content will usually fall to around 10-12% depending on the drying technique, climate, and length of time spent drying. As moisture content decreases, porosity increases.

As used herein, “infusion” refers to the process of filling the pores of a coffee bean with liquid.

As used herein, “porosity” is a measure of the empty space in a coffee bean, per total volume of the bean.

As used herein, the term “infuse” refers to filling the pores of a coffee bean with one or more derivatives.

As used herein, the terms “approximately” and “about,” as applied to one or more values of interest, refer to a value that is +/−10% of the recited value.

As used herein, the term “water” means one or more of tap water, potable water, mineral water from natural sources or formulated mineral water and distilled water.

### Methods of Making an Infused Coffee Product

The present disclosure includes additive infused coffee products. In one aspect, the infused coffee product is infused coffee beans. In one aspect, the infused coffee product is infused coffee bean grounds. In another aspect, the infused coffee product is infused cold brew.

In one aspect, the present disclosure includes a method of making an infused coffee bean product comprising a desired dosage of an additive, comprising the steps of:
(i) obtaining green coffee beans;
(ii) roasting the green coffee beans at an elevated temperature to a desired roast;
(iii) removing the roasted coffee beans of (ii) from heat;
(iv) cooling the roasted coffee beans to a temperature from 38° C.±3° C. to 121° C.±3° C.;
(v) moving the cooling roasted coffee beans of (iv) to a chamber for mixing the coffee beans;
(vi) obtaining an amount of an additive comprising a weight that is 3 wt % to 28 wt % higher than the desired dosage;
(vii) heating the additive to a temperature from 38° C.±3° C. to 21° C.±3° C.;
(viii) adding the heated additive of (vii) to the coffee beans of (v) in the chamber while mixing the roasted coffee beans;
(ix) mixing the coffee beans and additive for a period between 5 minutes and 40 minutes to produce infused coffee beans; and
(x) cooling the infused coffee beans to room temperature.

In one aspect, the desired roast is at least one of: light roast, medium roast, and dark roast.

In one aspect, the roasted coffee beans of (ii) are removed from heat at a temperature from about 180° C.±3° C. to about 230° C.±3° C. In one aspect, the roasted coffee beans of (iv) are maintained at a temperature of 38° C.±3° C. to 121° C.±3° C. while being transferred to the chamber for mixing. In one aspect, the coffee beans are maintained at a temperature from about 82° C.±3° C. to about 104° C.±3° C. throughout the mixing process. In one aspect, the coffee beans of the disclosure are maintained at a temperature from about 90±3° C. to 100±3° C. throughout the mixing process. In one aspect, the roasted coffee beans and additive are mixed for a period between 10 minutes and 30 minutes.

In one aspect, the present disclosure provides a method of making an infused coffee bean product comprising a desired dosage of an additive, comprising the steps of:
(1) obtaining roasted coffee beans of a desired roast;
(2) heating roasted coffee beans to a temperature of 65° C.±3° C. to 149° C.±3° C., wherein the coffee beans comprise a ratio of about 5% to about 200% oil by weight based on the total weight of the coffee beans;
(3) moving the coffee beans of (2) to a chamber for mixing the coffee beans;
(4) obtaining an amount of an additive comprising a weight that is 3 wt % to 28 wt % higher than the desired dosage;
(5) heating the additive to a temperature from 38° C.±3° C. to 121° C.±3° C.;
(6) adding the heated additive of (5) to the coffee beans of (3) in the chamber while mixing the roasted coffee beans;
(7) mixing the coffee beans and additive for a period between 5 minutes and 70 minutes to produced infused coffee beans; and
(8) cooling the infused coffee beans to room temperature.

In one aspect, the heated coffee beans of (2) comprise a ratio of about 9% to about 17% oil by weight based on the total weight of the coffee beans. In one aspect, the coffee beans are maintained at a temperature from 65° C.±3° C. to about 149° C.±3° C. throughout the mixing process. In one aspect, the coffee beans of the disclosure are maintained at a temperature from about 90±3° C. to 100±3° C. throughout the mixing process. In one aspect, the roasted coffee beans and additive are mixed for a period between 10 minutes and 60 minutes.

In one aspect, the additive added to roasted or green coffee beans is in the form of a water-soluble powder or water-based powder, an isolate, an oil, or an extract. In one aspect, the additive is introduced to water, distilled water, or mineralized water. In one aspect, the additive is heated to a temperature of 38° C.±3° C. to 121° C.±3° C.

In one aspect, the infused coffee beans of the disclosure are pasteurized after infusion. In one aspect, the pasteurization comprises (1) exposing the coffee beans to a temperature of 60° C.±3° C. to 100° C.±3° C. for 3 to 30 seconds and (2) exposing the coffee beans to 4° C.±3° C. to 93° C.±3° C. In one aspect, the coffee beans of (ii) or (2) and additives of (vi) or (4) are heated using a nonreactive heat source. In some aspects, the nonreactive heat source is ultraviolet light (UV-C), hot air, radiant, light source, or conductive heat.

In one aspect, the coffee beans of (6) or (viii) are mixed and/or tumbled at a rotating speed of 5 to 35 RPM. In some aspects, the coffee beans are mixed at a rotating speed of 10 to 30 RPM. In some aspects, the additive is added to the coffee beans at a ratio of about 0.1% to about 2.5% of the coffee beans' weight before heating or roasting. In some aspects, 3 wt % to 28 wt % of the additives added to the coffee beans are lost after heating or roasting. In some aspects, 5 wt % to 20 wt % of the additives added to the coffee beans are lost after heating or roasting.

In one aspect, the present disclosure provides a method of making a cold brew product, comprising:
(i) introducing ground coffee beans to a first volume of water in an airtight tank at:
   (1) a temperature from 38° C.±3° C. 90° C.±3° C. for less than 60 seconds; then
   (2) a temperature from 4° C.±3° C. to 93° C.±3° C. for less than 60 seconds
(ii) reducing the temperature of the tank to 0° C.±3° C. to 10° C.±3° C.;
(iii) steeping the coffee ground in water mixture for about 16 to 24 hours;
(iv) obtaining an amount of an additive at a desired dosage;
(v) introducing additives to water in a second airtight tank at a temperature from 37° C.±3° C. to 93.5° C.±3° C.;
(vi) filtering the coffee in water mixture of (iii) to remove the coffee grounds from the filtered coffee liquid, wherein the filtered coffee liquid is at a second volume that is about 20% less than the first volume; and
(vii) adding the additives in water mixture of (v) to the filtered coffee liquid of (vi) at a temperature of 18° C.±3° C. to 100° C.±3° C. to make the cold brew solution, wherein the added of the additive in water mixture is about 20% of the first volume.

In one aspect, the method further comprises packaging the cold brew solution of (vii) in a suitable container. In one aspect, the cold brew solution of (vi) is packaged under airtight conditions. In one aspect, the airtight condition is maintained through continuous circulation of a gas, wherein the gas is not oxygen. In one aspect, the gas is nitrogen or carbon dioxide. In one aspect, the pH of cold brew solution of (vi) is below 5. In one aspect, the suitable container is a can, a bottle, or a carton.

In one aspect, the cold brew solution of (vii) is pasteurized. In one aspect, the pasteurization introducing ground coffee beans to a first volume of water in an airtight tank at: (1) a temperature from 38° C.±3° C. 90° C.±3° C. for less than 60 seconds; then (2) a temperature from 4° C.±3° C. to 93° C.±3° C. for less than 60 seconds. In one aspect, the pasteurization comprises exposing the packaged cold brew to a temperature between 115° C.±3° C. to 130° C.±3° C. and pressure between 0.7±0.1 kg/cm² to 1.5±0.1 kg/cm². In one aspect, an antimicrobial is added to the cold brew solution of (vi).

In one aspect, the additive of (vi) is in the form of a water-soluble powder or water-based powder, an isolate, an oil, or an extract. In one aspect, the additive of (vii) is introduced to water, distilled water, mineralized water, milk, creamer, non-dairy milk substitute, or non-dairy creamer.

In one aspect, the additive of the disclosure is a cannabis extract containing cannabinoids. In some aspects, the cannabinoid is THC (tetrahydrocannabinol, including delta-9, delta-8-, delta-10-tetrahydrocannabinol), THCV (Tetrahydrocannabivarin) THCA (tetrahydrocannabinolic acid). CBD (cannabidiol), CBDA (cannabidiolic acid), CBN (cannabinol), CBG (cannabigerol), CBC (cannabichromene), CBL (cannabicyclol), CBV (cannabivarin), THCC (tetrahydrocannabiorcol), THCV (tetrahydrocannabivarin), THCP (tetrahydrocannabiphorol), CBDV (cannabidivarin), CBCV (cannabichromevarin), CBGV (cannabigerovarin), CBGM (cannabigerol monomethyl ether), CBE (cannabielsoin), CBT (cannabicitran) and mixtures thereof.

Cannabinoids such as CBD degrade at 140° C.; CBDA degrades at least at 120° C.; both CBD and THC begin to show degradation effects with decreased quantities at 160° C.; and other cannabinoids begin to show the trend of degradation at this same temperature. (See, e.g., García-Valverde M T, et. al., Effect of temperature in the degradation of cannabinoids: From a brief residence in the gas chromatography inlet port to a longer period in thermal treatment, Front. Chem. (2022)).

In some aspects, the roasted coffee beans and additive are mixed at a ratio between 1000:1 to 40:1 on a per weight basis after accounting for loss of 3 wt % to 28 wt % of the additives added to the coffee beans after heating compared to the additives' weight before heating.

In some aspects, the additive is an adaptogen. In some aspects, the adaptogen is ashwagandha, Rhodiola rosea, Panax ginseng, Panax quinquefolius, holy basil, eleuthero, Cordyceps, reishi, maca, Schisandra, or licorice root. Adaptogens (such as Ashwagandha, Rhodiola rosea, Ginseng, Holy Basil, Cordyceps, reishi, Maca, Schisandra, Licorice Root) and amino acids (such as L-theanine and GABA) are widely recognized and commonly used for their potential stress-reducing, energy-boosting, and overall well-being-promoting properties and have been used for centuries in traditional medicine systems. Adaptogens work by modulating the body's stress response and supporting the adrenal glands. Unlike stimulants, they provide sustained energy and promote balance. They are believed to offer benefits such as increased resilience to stress, improved mental clarity and physical performance, enhanced immune function, and overall well-being.

In some aspects, the additive is a hemp extract. In some aspects, the additive is an amino acid. In some aspects, the amino acid is L-theanine, or GABA (γ-aminobutyric acid). In some aspects, the additive is a vitamin. In some aspects, the additive is a terpene. In some aspects, the terpene is myrcene, limonene, pinene, caryophyllene, and linalool.

In one aspect, the additive contains a cannabinoid and at least one of a terpene, an adaptogen, an amino acid, or a vitamin.

In one aspect, a beverage according to the present disclosure may be in a can, bottle, or carton. A non-pasteurization process may comprise an antimicrobial functional preservative that achieves the same level of antimicrobial efficacy as Tunnel Pasteurization. The objective is to ensure the cold brew product achieves shelf stability. Additionally, the process aims to maintain the cold brew's pH level below 5. To prevent oxygen exposure, the process is completely airtight, with continuous circulation of either nitrogen, CO2 or other gas within the system until the product is canned.

The process consists of the following steps:

Step 1: Coffee grounds are added to a tank.

Step 2: The coffee grounds are exposed to hot water in a 3 to 30-second flash, or cold water within a temperature range of 39° F. to 200° F. (close to freezing-close to boiling). This step releases the natural flavors of the coffee.

Step 3: The coffee grounds are steeped in cold water, close to freezing temperatures ranging from 33° F. to 50° F., for 15 to 24 hours.

Step 4: The cold brew liquid is separated from the coffee grounds and transferred to a temperature-controlled tank, leaving a 20% liquid deficit compared to the initial water volume.

Step 5: In a separate tank, a homogenized solution of water and formula (i.e., formulated additive (cannabinoid, terpene, and/or adaptogenic compound(s))) is prepared at a temperature ranging from 65° F. to 212° F. This solution is used to fill the 20% water deficit mentioned in step four.

Step 6: Once the tank in step four reaches the intended liquid level for the cold brew run, the cold brew is pumped into the canning line for packaging.

Alternatively, pasteurization and packing in cans, bottles, Cartons or any other container may be used. This process incorporates an antimicrobial functional preservative that achieves the same level of antimicrobial efficacy as Tunnel Pasteurization. Its objective is to ensure the cold brew product achieves shelf stability. Additionally, the process aims to maintain the cold brew's pH level below 5, the cold brew liquid undergoes flash pasteurization, a process that briefly exposes it to high temperatures ranging from 122 F to 210 F to ensure microbial safety and then quickly cool the liquid coffee.

To prevent oxygen exposure, the process is completely airtight, with continuous circulation of either nitrogen, CO2 or other inert gas within the system until the product is packed.

The process consists of the following steps:

Step 1: Coffee grounds are added to a tank.

Step 2: The coffee grounds are exposed to hot water in a 3 to 30-second flash, or cold water within a temperature range of 39° F. to 200° F. (close to freezing-close to boiling). This step releases the natural flavors of the coffee.

Step 3: The coffee grounds are steeped in cold water, close to freezing temperatures ranging from 33° F. to 50° F., for 15 to 24 hours.

Step 4: The cold brew liquid is separated from the coffee grounds and transferred to a temperature-controlled tank, leaving a 20% liquid deficit compared to the initial water volume.

Step 5: In a separate tank, a homogenized solution of water and formula (i.e., formulated additive (cannabinoid, terpene, and/or adaptogenic compound(s))) is prepared at a temperature ranging from 65° F. to 212° F. This solution is used to fill the 20% water deficit mentioned in step four.

Step 6: Once the tank in step four reaches the intended liquid level for the cold brew run, the cold brew is pumped into the canning line for packaging.”

The present disclosure includes the following non-limiting list of items:
1. A method of making an infused coffee bean product comprising a desired dosage of an additive, comprising the steps of:
   (i) obtaining green coffee beans;
   (ii) roasting the green coffee beans at an elevated temperature;
   (iii) removing the roasted coffee beans of step (ii) from heat;
   (iv) cooling the roasted coffee beans to a temperature between about 60° C. and about 130° C.;
   (v) placing the roasted coffee beans of step (iv) in a chamber;
   (vi) heating an additive to a temperature between about 35° C. and about 130° C.;
   (vii) adding the heated additive of step (vii) to the roasted coffee beans of step (v) in the chamber while mixing and/or tumbling the roasted coffee beans; and
   (viii) mixing the roasted coffee beans and the additive to produce infused coffee beans,
or
   (1) obtaining roasted coffee beans (e.g., having a desired roast), wherein the roasted coffee beans may be at or below room temperature;
   (2) heating the roasted coffee beans to a temperature between about 60° C. and about 155° C.;
   (3) placing the roasted coffee beans of step (2) in a chamber for mixing the coffee beans;
   (4) heating an additive to a temperature from 38° C.±3° C. to 121° C.±3° C.;
   (5) adding the heated additive of step (4) to the roasted coffee beans of (3) in the chamber while mixing the roasted coffee beans; and
   (6) mixing and/or tumbling the coffee beans and the additive for a period between about 5-75 minutes to produce infused coffee beans.
2. A method of making an infused coffee bean product comprising a desired dosage of an additive, comprising the steps of:
   (i) obtaining green coffee beans;
   (ii) roasting the green coffee beans at an elevated temperature to a desired roast;
   (iii) removing the roasted coffee beans of (ii) from heat;
   (iv) cooling the roasted coffee beans to a temperature from 38° C.±3° C. to 121° C.±3° C.;
   (v) moving the cooling roasted coffee beans of (iv) to a chamber for mixing the coffee beans;
   (vi) obtaining an amount of an additive comprising a weight that is 3 wt % to 28 wt % higher than the desired dosage;
   (vii) heating the additive to a temperature from 63° C.±3° C. to 21° C.±3° C.;
   (viii) adding the heated additive of (vii) to the coffee beans of (v) in the chamber while mixing the roasted coffee beans;
   (ix) mixing and/or tumbling the coffee beans and additive for a period between 5 minutes and 40 minutes to produce infused coffee beans; and
   (x) cooling the infused coffee beans to room temperature;
   or,
   (1) obtaining roasted coffee beans of a desired roast;
   (2) heating roasted coffee beans to a temperature of 65° C.±3° C. to 149° C.±3° C., wherein the coffee beans comprise a ratio of about 5% to about 200% oil by weight based on the total weight of the coffee beans;
   (3) moving the coffee beans of (2) to a chamber for mixing the coffee beans;
   (4) obtaining an amount of an additive comprising a weight that is 3 wt % to 28 wt % higher than the desired dosage;
   (5) heating the additive to a temperature from 38° C.±3° C. to 121° C.±3° C.;
   (6) adding the heated additive of (5) to the coffee beans of (3) in the chamber while mixing the roasted coffee beans;
   (7) mixing and/or tumbling the coffee beans and additive for a period between 5 minutes and 70 minutes to produced infused coffee beans; and
   (8) cooling the infused coffee beans to room temperature.
3. The method of item 1 or item 2, wherein the heated coffee beans of (2) comprise a ratio of about 9% to about 17% oil by weight based on the total weight of the coffee beans.
4. The method of any one of items 1-3, wherein the roasted coffee beans of (ii) are removed from heat at a temperature from 180° C.±3° C. to 230° C.±3° C.
5. The method of any one of items 1-4, wherein the coffee beans are maintained at a temperature from 82° C.±3° C. to 104° C.±3° C. throughout the mixing process.
6 The method of any one of items 1-5, wherein roasted coffee beans and additive are mixed and/or tumbled for a period between 10 minutes and 60 minutes.
7. The method of any one of items 1-5, wherein the roasted coffee beans and additive are mixed at a ratio between 1000:1 to 40:1 on a per weight basis after accounting for loss of 3 wt % to 28 wt % of the additives added to the coffee beans after heating compared to the additives' weight before heating.
8. The method of any one of items 1-7, wherein the additive is added to the coffee beans at a ratio of about 0.1 wt % to about 2.5 wt % of the weight of the coffee beans at (i) or (1).
9. The method of any one of items 1-8, wherein 3 wt % to 28 wt % of the additives added to the coffee beans are lost after heating compared to the additives' weight before heating.
10. The method of any one of items 1-9, wherein the infused coffee beans of step (x) or (8) are cooled at room temperature.
11. The method of any one of items 1-10, wherein the infused coffee beans are pasteurized.
12. The method of any one of items 1-11, wherein the additive is a cannabis extract containing cannabinoids.
13. The method of item 12, wherein the cannabinoid is THC (tetrahydrocannabinol, including delta-9-, delta-8-, delta-10-tetrahydrocannabinol), THCV (Tetrahydrocannabivarin) THCA (tetrahydrocannabinolic acid). CBD (cannabidiol), CBDA (cannabidiolic acid), CBN (cannabinol), CBG (cannabigerol), CBC (cannabichromene), CBL (cannabicyclol), CBV (cannabivarin), THCC (tetrahydrocannabiorcol), THCV (tetrahydrocannabivarin), THCP (tetrahydrocannabiphorol), CBDV (cannabidivarin), CBCV (cannabichromevarin), CBGV (cannabigerovarin), CBGM (cannabigerol monomethyl ether), CBE (cannabielsoin), CBT (cannabicitran) and mixtures thereof.
14. The method of any one of items 1-13, wherein the additive contains a cannabinoid and at least one of a terpene, an adaptogen, an amino acid, or a vitamin.
15. The method of item 14, wherein the additive comprises the cannabinoid in a ratio of 1:10 to 10:1 to the at least one of a terpene, an adaptogen, an amino acid, or a vitamin.
16. The method of item 15, wherein the additive comprises the cannabinoid in a ratio of 1:10 to 10:1 to the adaptogen.
17. The method of any one of items 1-16, wherein the additive comprises a cannabinoid in combination with ashwagandha, Rhodiola rosea, Panax ginseng, Panax quinquefolius, holy basil, eleuthero, Cordyceps, reishi, maca, Schisandra, licorice root, or a combination thereof.
18. The method of any one of items 1-17, wherein a steam condensate with additive and flavor is applied to the infused coffee beans.
19. A method of making a cold brew product comprising a desired dosage of an additive, comprising the steps of:
   (i) introducing ground coffee beans to a first volume of water in an airtight tank at:
      (1) a temperature from 38° C.±3° C. to 90° C.±3° C. for less than 60 seconds, then
      (2) a temperature from 4° C.±3° C. to 93° C.±3° C. for less than 60 seconds;
   (ii) reducing the temperature of the tank to 0° C.±3° C. to 10° C.±3° C.;
   (iii) steeping the coffee ground in water mixture for about 16 to 24 hours;
   (iv) obtaining an amount of an additive at a desired dosage;
   (v) introducing the additive to water, distilled water or mineral water in a second airtight tank at a temperature from 37° C.±3° C. to 93.5° C.±3° C.;
   (vi) filtering the coffee in water mixture of (iii) to remove the coffee grounds from the filtered coffee liquid, wherein the filtered coffee liquid is at a second volume that is about 20% less than the first volume; and
   (vii) adding the additive in water mixture of (v) to the filtered coffee liquid of step (vi) at a temperature of 18° C.±3° C. to 100° C.±3° C. to make the cold brew solution, wherein the added of the additive in water mixture is about 20% of the first volume.
20. The method of item 19, further comprising packaging the cold brew solution of (vii) in a suitable container under airtight conditions.
21. The method of item 19 or item 20, wherein the pH of cold brew solution is below 5.
22. The method of any one of items 19-21, wherein the cold brew solution is pasteurized.
23. The method of any one of items 19-22, wherein an antimicrobial is added to the cold brew solution.
24 The method of any one of items 19-23, wherein the additive is a cannabis extract containing cannabinoids and optionally at least one of a terpene, an adaptogen, an amino acid, or a vitamin.
25. The method of item 24, wherein the additive comprises the cannabinoid in a ratio of 1:10 to 10:1 to the at least one of a terpene, an adaptogen, an amino acid, or a vitamin.
26. The method of item 24, wherein the additive comprises the cannabinoid in a ratio of 1:10 to 10:1 to the adaptogen.
27. The method of any one of items 19-26, wherein the additive comprises a cannabinoid in combination with ashwagandha, Rhodiola rosea, Panax ginseng, Panax quinquefolius, holy basil, eleuthero, Cordyceps, reishi, maca, Schisandra, licorice root, or a combination thereof.
28. The method of any one of items 19-27, wherein a steam condensate with additive and flavor is added to the cold brew solution.
29. The method of any one of items 19-28, wherein the ratio of coffee to water in step (i) is about 1:3 to about 1:6 or about 1:4 to about 1:5.
30. The method of any one of items 1-29, wherein the additive comprises a 1:1 ratio by weight of CBD:CBG.
31. The method of any one of items 1-29, wherein the additive comprises CBD, CBN, and CBG.
32. The method of any one of items 1-29, wherein the additive comprises 80-95% w/w CBD and 3-7% w/w CBG.
33. A can, bottle, or carton comprising a beverage produced by the method of any one of items 19-32.

### Example 1

Starting from Green Coffee Beans:
1. Green Coffee Beans Selection:
   a. High-quality green coffee beans were selected and weighed, estimating a 15 wt % to 25 wt % weight loss after roasting.
2. Roasting the Green Beans:
   a. The green coffee beans were roasted. In various runs, the beans were roasted to various desired roasts, e.g., light, medium, and dark.
   b. The roasted beans came out from the roasting machine at a temperature range of 356° F. to 446° F. (180° C. to 230° C.), depending on the roasting style.
3. Cooling the Roasted Beans:
   a. The roasted coffee beans were cooled to a temperature between 150° F. to 250° F. (65° C. to 121° C.).
4. Moving Coffee to Mixer:
   a. Immediately transferred the roasted coffee beans to a tumbler or mixer.
   b. Maintained the roasted coffee's temperature at 65° C. to 121° C. during the transfer.
5. Adding additive, e.g., Hemp and Cannabis Extract:
   a. Heated the additive to a range between 100° F. up to 250° F. before adding to the tumbling beans. (38° C. to 121° C.).
   b. Added the formulated additive (cannabinoids, terpene, and/or adaptogenic) formula in liquid or solid form to the coffee beans while it was being tumbled or moved for mixing.
   c. This tumbling or moving the beans ensured even distribution and homogenizing of the extract among all the coffee beans.
   d. The ratio between the coffee and formula was a range between 1000:1 to 40:1 on a per weight basis is determined by the desired dosage of formula infused in the final product, is accounted for the mass loss due to counting in slippage from 3% to 28% of the formula infused.
6. Controlling Mixer Settings:
   a. Controlled the mixer at a rotating speed of 10 to 30 RPM.
   b. Maintained the mixer temperature at a range of 220° F. to 180° F. (104° C. to 82° C.).
7. Mixing for Optimal Homogenization:
   a. Mixed the coffee and extract formula in the tumbler and or mixer for a duration of 10 to 30 minutes to give enough time to the coffee beans to absorb the formula.
   b. This allowed for optimal mixing, adsorption, diffusion and homogenizing of the coffee beans with the extract.
8. Cooling Off:
   a. Once the mixing duration was completed, allowed the batch to cool off naturally and slowly to room temperature.

### Example 2

Starting from Roasted Beans:

### Prepared the Roasted Beans:

a. Started with roasted coffee beans (not green) at room temperature.
b. Heated the beans to a range of 300° F. to 150° F.

### Determined Extract Concentration:

a. Measured the oil content of the coffee of the desired range between 9% to 17% using gas chromatography (GC) or any other analytical method.

### Activated Extract and Bean Chemical Interaction:

a. Heated the formulated hemp and cannabis extract concentrate to a desired temperature of 100° F. up to 250° F. (38° C. to 121° C.).
b. Applied the heated extract to the chemically active roasted beans, e.g., by spraying, pouring or melting the extract onto the heated beans.

### Mixed the Beans:

a. Used a mixer with a heat-controlled system to mix the beans while incorporating the extract.
b. Set the mixer to a rotational speed of 10 to 30 RPM.
c. Introduced the roasted beans into the mixer at a temperature range of 300° F. to 150° F. or between 194-212° F.
d. Maintained the temperature range throughout the mixing process.

### Ensured Equal Infusion Distribution:

a. Rotated the beans in the mixer for a duration of 10 minutes to 60 minutes at the maintained temperature.
b. The ratio between the coffee and formula was in a range between 1000:1 to 40:1 on a per weight basis is determined by the desired dosage of formula infused in the final product, is accounted for the mass loss due to counting in slippage from 3% to 28% of the formula infused.

### Cooled Down:

a. After the desired mixing duration, stopped the application of heat by the mixer.
b. Allowed the roasted infused beans to cool down naturally to room temperature.
c. This cooling process facilitated a chemical binding between the formulated extract concentration and the natural oils of the beans.

### Additional Health and Wellness Compounds:

a. Other health and wellness adaptogenic compounds were added to the formula.
b. These additional compounds contribute to standardization and repeatability of the process.

Each of the aspects of the present disclosure can encompass various elements of the present disclosure. It is, therefore, anticipated that each of the aspects of the present disclosure involving any one element or combinations of elements can be included in each aspect of the present disclosure. This disclosure is not limited in its application to the details of construction and the arrangement of components set forth in the following detailed description or illustrated in the drawings.

Although the present disclosure is described in detail below, it is to be understood that this disclosure is not limited to the particular methodologies, protocols and reagents described herein as these may vary. It is also to be understood that the terminology used herein is for the purpose of describing particular aspects only, and is not intended to limit the scope of the present disclosure. Unless defined otherwise, all technical and scientific terms used herein have the same meanings as commonly understood by one of ordinary skill in the art.

1. A method of making an infused coffee bean product comprising a desired dosage of an additive, comprising the steps of:
(i) obtaining green coffee beans;
(ii) roasting the green coffee beans at an elevated temperature;
(iii) removing the roasted coffee beans of step (ii) from heat;
(iv) cooling the roasted coffee beans to a temperature between about 60° C. and about 130° C.;
(v) placing the roasted coffee beans of step (iv) in a chamber;
(vi) heating an additive to a temperature between about 35° C. and about 130° C.;
(vii) adding the heated additive of step (vii) to the roasted coffee beans of step (v) in the chamber while mixing and/or tumbling the roasted coffee beans; and
(viii) mixing the roasted coffee beans and the additive to produce infused coffee beans, or
(1) obtaining roasted coffee beans (e.g., having a desired roast), wherein the roasted coffee beans may be at or below room temperature;
(2) heating the roasted coffee beans to a temperature between about 60° C. and about 155° C.;
(3) placing the roasted coffee beans of step (2) in a chamber for mixing the coffee beans;
(4) heating an additive to a temperature from 38° C.±3° C. to 121° C.±3° C.;
(5) adding the heated additive of step (4) to the roasted coffee beans of (3) in the chamber while mixing the roasted coffee beans; and
(6) mixing and/or tumbling the coffee beans and the additive for a period between about 5-75 minutes to produce infused coffee beans.

2. The method of claim 1, wherein the method is further characterized by either:
(i) obtaining green coffee beans;
(ii) roasting the green coffee beans at an elevated temperature to a desired roast;
(iii) removing the roasted coffee beans of (ii) from heat;
(iv) cooling the roasted coffee beans to a temperature from 38° C.±3° C. to 121° C.±3° C.;
(v) moving the cooling roasted coffee beans of (iv) to a chamber for mixing the coffee beans;
(vi) obtaining an amount of an additive comprising a weight that is 3 wt % to 28 wt % higher than the desired dosage;
(vii) heating the additive to a temperature from 63° C.±3° C. to 21° C.±3° C.;
(viii) adding the heated additive of (vii) to the coffee beans of (v) in the chamber while mixing the roasted coffee beans;
(ix) mixing and/or tumbling the coffee beans and additive for a period between 5 minutes and 40 minutes to produce infused coffee beans; and
(x) cooling the infused coffee beans to room temperature;
or,
(1) obtaining roasted coffee beans of a desired roast;
(2) heating roasted coffee beans to a temperature of 65° C.±3° C. to 149° C.±3° C., wherein the coffee beans comprise a ratio of about 5% to about 200% oil by weight based on the total weight of the coffee beans;
(3) moving the coffee beans of (2) to a chamber for mixing the coffee beans;
(4) obtaining an amount of an additive comprising a weight that is 3 wt % to 28 wt % higher than the desired dosage;
(5) heating the additive to a temperature from 38° C.±3° C. to 121° C.±3° C.;
(6) adding the heated additive of (5) to the coffee beans of (3) in the chamber while mixing the roasted coffee beans;
(7) mixing and/or tumbling the coffee beans and additive for a period between 5 minutes and 70 minutes to produced infused coffee beans; and
(8) cooling the infused coffee beans to room temperature.

3. The method of claim 1, wherein the heated coffee beans of (2) comprise a ratio of about 9% to about 17% oil by weight based on the total weight of the coffee beans.

4. The method of claim 1, wherein the roasted coffee beans of (ii) are removed from heat at a temperature from 180° C.±3° C. to 230° C.±3° C.

5. The method of claim 1, wherein the coffee beans are maintained at a temperature from 82° C.±3° C. to 104° C.±3° C. throughout the mixing process.

6. The method of claim 1, wherein roasted coffee beans and additive are mixed and/or tumbled for a period between 10 minutes and 60 minutes.

7. The method of claim 1, wherein the roasted coffee beans and additive are mixed at a ratio between 1000:1 to 40:1 on a per weight basis after accounting for loss of 3 wt % to 28 wt % of the additives added to the coffee beans after heating compared to the additives' weight before heating.

8. The method of claim 1, wherein the additive is added to the coffee beans at a ratio of about 0.1 wt % to about 2.5 wt % of the weight of the coffee beans at (i) or (1).

9. The method of claim 1, wherein 3 wt % to 28 wt % of the additives added to the coffee beans are lost after heating compared to the additives' weight before heating.

10. The method of claim 2, wherein the infused coffee beans of step (x) or (8) are cooled at room temperature.

11. The method of claim 1, wherein the infused coffee beans are pasteurized.

12. The method of claim 1, wherein the additive is a cannabis extract containing cannabinoids.

13. The method of claim 12, wherein the cannabinoid is THC (tetrahydrocannabinol, including delta-9-, delta-8-, delta-10-tetrahydrocannabinol), THCV (Tetrahydrocannabivarin) THCA (tetrahydrocannabinolic acid). CBD (cannabidiol), CBDA (cannabidiolic acid), CBN (cannabinol), CBG (cannabigerol), CBC (cannabichromene), CBL (cannabicyclol), CBV (cannabivarin), THCC (tetrahydrocannabiorcol), THCV (tetrahydrocannabivarin), THCP (tetrahydrocannabiphorol), CBDV (cannabidivarin), CBCV (cannabichromevarin), CBGV (cannabigerovarin), CBGM (cannabigerol monomethyl ether), CBE (cannabielsoin), CBT (cannabicitran) and mixtures thereof.

14. The method of claim 1, wherein the additive contains a cannabinoid and at least one of a terpene, an adaptogen, an amino acid, or a vitamin.

15. The method of claim 14, wherein the additive comprises the cannabinoid in a ratio of 1:10 to 10:1 to the at least one of a terpene, an adaptogen, an amino acid, or a vitamin.

16. The method of claim 15, wherein the additive comprises the cannabinoid in a ratio of 1:10 to 10:1 to the adaptogen.

17. The method of claim 1, wherein the additive comprises a cannabinoid in combination with ashwagandha, Rhodiola rosea, Panax ginseng, Panax quinquefolius, holy basil, eleuthero, Cordyceps, reishi, maca, Schisandra, licorice root, or a combination thereof.

18. The method of claim 1, wherein a steam condensate with additive and flavor is applied to the infused coffee beans.

19. A method of making a cold brew product comprising a desired dosage of an additive, comprising the steps of:
(i) introducing ground coffee beans to a first volume of water in an airtight tank at:
(1) a temperature from 38° C.±3° C. to 90° C.±3° C. for less than 60 seconds, then
(2) a temperature from 4° C.±3° C. to 93° C.±3° C. for less than 60 seconds;
(ii) reducing the temperature of the tank to 0° C.±3° C. to 10° C.±3° C.;
(iii) steeping the coffee ground in water mixture for about 16 to 24 hours;
(iv) obtaining an amount of an additive at a desired dosage;
(v) introducing the additive to water, distilled water or mineral water in a second airtight tank at a temperature from 37° C.±3° C. to 93.5° C.±3° C.;
(vi) filtering the coffee in water mixture of (iii) to remove the coffee grounds from the filtered coffee liquid, wherein the filtered coffee liquid is at a second volume that is about 20% less than the first volume; and
(vii) adding the additive in water mixture of (v) to the filtered coffee liquid of step (vi) at a temperature of 18° C.±3° C. to 100° C.±3° C. to make the cold brew solution, wherein the added of the additive in water mixture is about 20% of the first volume.

20. The method of claim 19, further comprising packaging the cold brew solution of (vii) in a suitable container under airtight conditions.

21. The method of claim 19, wherein the pH of cold brew solution is below 5, or wherein the cold brew solution is pasteurized, or
wherein an antimicrobial is added to the cold brew solution, or
wherein the additive is a cannabis extract containing cannabinoids and optionally at least one of a terpene, an adaptogen, an amino acid, or a vitamin, or
wherein the additive comprises the cannabinoid in a ratio of 1:10 to 10:1 to the at least one of a terpene, an adaptogen, an amino acid, or a vitamin, or
wherein the additive comprises the cannabinoid in a ratio of 1:10 to 10:1 to the adaptogen, or
wherein the additive comprises a cannabinoid in combination with ashwagandha, Rhodiola rosea, Panax ginseng, Panax quinquefolius, holy basil, eleuthero, Cordyceps, reishi, maca, Schisandra, licorice root, or a combination thereof, or
wherein a steam condensate with additive and flavor is added to the cold brew solution, or
wherein the ratio of coffee to water in step (i) is about 1:3 to about 1:6 or about 1:4 to about 1:5, or
wherein the additive comprises a 1:1 ratio by weight of CBD:CBG, or
wherein the additive comprises CBD, CBN, and CBG, or
wherein the additive comprises 80-95% w/w CBD and 3-7% w/w CBG.
